(19) United States
(12) Patent Application Publication
(10) Pub. No.: US 2007/0280214 A1
(43) Pub. Date: Dec. 6, 2007

(54) Method and apparatus for providing electronic mail and voicemail retrieval

(75) Inventors: John P. Dowens, Red Bank, NJ (US); Marius Gudelis, Holmdel, NJ (US)

Correspondence Address: AT&T CORP., ROOM 2A207, ONE AT&T WAY, BEDMINSTER, NJ, 07921, US

(73) Assignee: AT&T Corp.

(21) Appl. No.: 11/444,848

(22) Filed: May 31, 2006

(51) Int. Cl. H04L 12/66

(52) U.S. Cl. 370/356

(57) ABSTRACT

A method and apparatus for retrieving electronic mail and voicemail on packet networks such as Voice over Internet Protocol (VoIP) and Service over Internet Protocol (SoIP) networks are disclosed. For example, a customer subscribes to a messaging service(s) where voicemail and/or email destined to the customer's IP phone can be accessed from a second endpoint device, where the IP phone and the second endpoint device are different devices. In one embodiment, the network service provider allows the second endpoint device that is deployed on another network, e.g., a wireless network, to access the stored messages in a particular presentation format (e.g., an audio format or a text format).

The present invention relates generally to communication networks and, more particularly, to a method for retrieving electronic mail or voicemail using text and audio messaging in packet networks such as Voice over Internet Protocol (VoIP) and Service over Internet Protocol (SOIP) networks.

### BACKGROUND OF THE INVENTION

The Internet has emerged as a critical communication infrastructure, carrying traffic for a wide range of important applications. Internet services such as VoIP and SoIP services are becoming ubiquitous and more and more businesses and consumers are utilizing these networks to obtain services from any location with an Internet connection. For example, customers may combine their data and voice services on an Internet based infrastructure such as VoIP and access the services from any location with Internet access. Generally, VoIP customers will access services such as voicemail, electronic mail (email) using their IP phones. However, one of the concerns customers have about these services is that the customers may be away from their IP phones when they need to retrieve their messages.

Therefore there is a need for a method that enables a VoIP or SoIP service provider to enable a customer to retrieve messages without using the IP phone.

### SUMMARY OF THE INVENTION

In one embodiment, the present invention discloses a method and apparatus for retrieving email and voicemail messages on packet networks such Voice over Internet Protocol (VoIP) and Service over Internet Protocol (SoIP) networks without using an IP phone. For example, a customer subscribes to a messaging service(s) where voicemail and/or email destined to the customer's IP phone can be accessed from a second endpoint device, where the IP phone and the second endpoint device are different devices. In one embodiment, the network service provider allows the second endpoint device that is deployed on another network, e.g., a wireless network, to access the stored messages in a particular presentation format (e.g., an audio format or a text format).

In one embodiment, the service provider also enables the user to provide preferences for receiving messages, e.g. a format for reviewing header information prior to selection of a message, a format for receiving messages (audio or text), etc. The service provider then enables the servers to interact with the customer and to provide the messages according to the preferences.

In one embodiment, the service provider also alerts the customer's second endpoint device such as a wireless phone, as to the presence of a new message, e.g., a new email or a new voicemail.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with one embodiment of the present invention for retrieving messages without an IP phone;

FIG. 3 illustrates a flowchart of a method for retrieving email and voicemail messages without an IP phone; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for retrieving email and voicemail messages where services are provided on networks such as VoIP or SoIP networks. Although the present invention is discussed below in the context of calls in VoIP and SoIP networks, the present invention is not so limited. Namely, the present invention can be applied for other networks with mobile customers. Similarly, the present invention can be implemented in an IP multimedia services network (e.g., in accordance with the 3GPP standard).

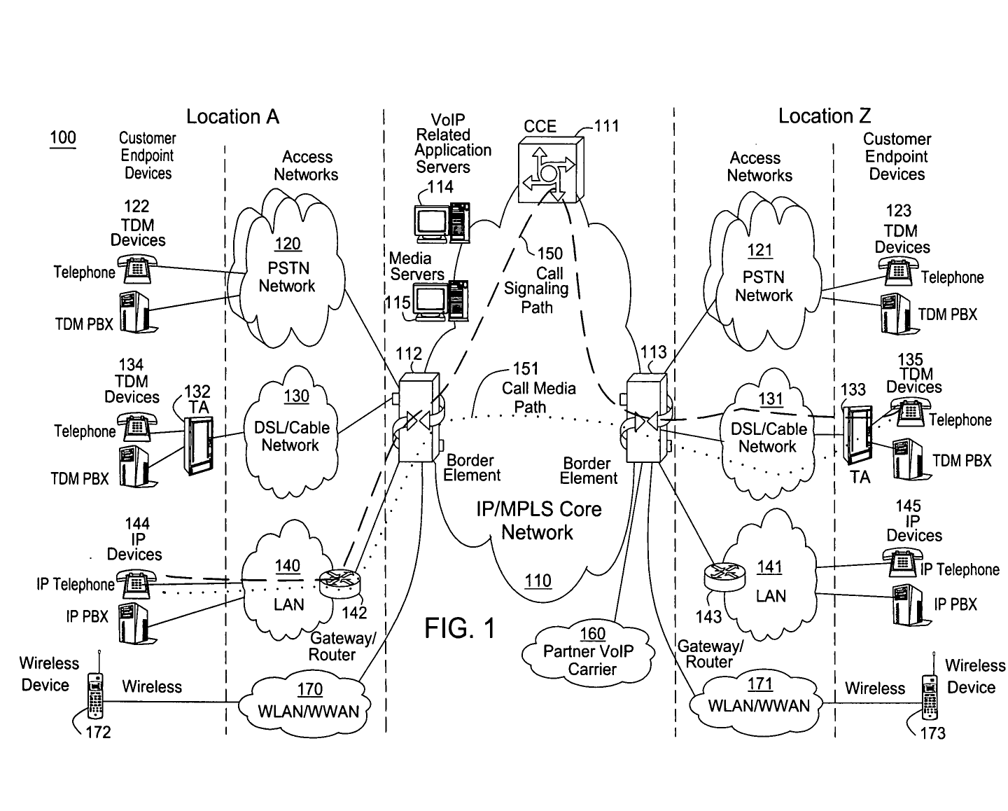

To better understand the present invention, FIG. 1 illustrates an example network 100, e.g., a packet network such as a VoIP network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as limited by this particular illustrative architecture.

The customer endpoint devices can be either Time Division Multiplexing (TDM) based, IP based or wireless such as cellular phones. TDM based customer endpoint devices 122, 123, 134, and 135 typically comprise of TDM phones or Private Branch Exchange (PBX). IP based customer endpoint devices 144 and 145 typically comprise IP phones or IP PBX. Wireless endpoint devices 172 and 173, typically comprise cellular phones, pocket PCs etc. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 which has a VoIP gateway router 142 or 143, as shown in FIG. 1. Wireless endpoint devices access VoIP services by using Wireless Local Area Networks (WLAN) or Wireless Wide Area Networks (WWAN) 170 and 171. The WLAN/WWAN networks 170 and 171 are connected to the IP core network 110 through the border elements 112 and 113, respectively.

The access networks for wired devices can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices. The access network for wireless devices 170 and 171 can be WLAN, WWAN or an integrated WLAN/WWAN network.

The core VoIP infrastructure comprises of several key VoIP components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

Media Servers (MS) 115 are special servers that typically handle and terminate media streams, and to provide services such as announcements, bridges, transcoding, and Interactive Voice Response (IVR) messages for VoIP service applications. The media servers also interact with customers for media session management to accomplish tasks such as process requests.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

The above network is described to provide an illustrative environment in which services are provided on networks such as VoIP and SoIP networks. Businesses are now able to expand their customer base beyond their local area network based on reaching customers via the Internet. For example, a VoIP service customer can subscribe to an email or voicemail service and access the service via an IP device. Customers expect to be able to communicate from anywhere. However, a customer of a VoIP service may be traveling away from the IP device when he/she wishes to retrieve the messages. For example, a nomadic customer may have his/her cell phone and may have access to a cellular network but may not be able to reach the IP device or TA used for VoIP services. One of the concerns customers have is that they may be away from their IP phone when they need to retrieve their messages. Therefore, there is a need for a method that enables the VoIP or SoIP service provider to enable a customer to retrieve messages without using an IP phone.

The current invention discloses a method and apparatus for retrieving voicemail and email messages in audio or text format without requiring an IP phone. In order to clearly illustrate the teachings of the current invention, the following terminologies and networking concepts will first be described:

A router;

A cable modem; and

A DSL modem.

A router is a networking device used to forward packets towards their destination using the Layer-3 networking protocol such as IP. In the home or small office environment, it can be used to handle the sharing of the Internet connection. For example, a customer may access VoIP or SoIP services using one or more endpoint devices that are connected to a network. The interconnection can utilize a variety of technologies such as a wireless connection, a Ethernet based connection, telephone lines, etc. Thus, the router may have address translation capability to allow multiple computers to access the Internet using a single public IP address. The router in this environment may also contain a firewall, a Ethernet hub and/or a wireless hub. When analog phones are used to access VoIP services, the router may also include RJ-11 ports for connecting with the TA. Hence, the router may have a variety of ports such as Ethernet ports, RJ-11 ports, and wireless ports to enable the sharing of a network connection and a port for connecting to either a DSL or Cable broadband network.

A cable modem is a device used to access the information contained on the channels transmitted on a coaxial cable. A cable modem contains at least a tuner for selection of frequencies, a demodulator for converting the radio frequency signals to signals that vary with voltage, an analog to digital converter, a Media Access Control (MAC) and a processor. If it is used for Internet access it also contains a digital to analog converter and a modulator. When a home network is connected to the cable network through the router, different channels are used for the CATV and Internet services such as VoIP. The cable modem separates the channels for the Internet services and the CATV. The packets on the channels for Internet services are forwarded to the router. If only one computer is connected to the Internet, the computer can be directly connected to the cable modem without the router.

A Digital Subscriber Line (DSL) modem is a device with modulation scheme used to connect data devices such as a computer for transporting packets on the telephone network. DSL uses existing phone lines to connect to the Internet.

To access a broadband service, the appropriate modems are utilized based on the type of broadband access and the customer's network such as whether the home or office network is connected to either a telephone network or a coaxial cable network. In order to originate a call using an analog device, the analog device is attached to a terminal adaptor that is, in turn, connected to either a router or directly to a broadband modem. The modem used for broadband access (DSL or cable) typically remains stationary. However, a nomadic VoIP or SoIP customer without access to the IP endpoint device and terminal adaptor may still wish to continue accessing IP services. For example, the customer may be traveling with a cellular phone and may wish to access the VoIP or SoIP messages for the home or office telephone number via the cellular phone. The current invention addresses this need by enabling a network service provider to provide a voicemail or email service on a VoIP or SoIP network that can be retrieved without the IP device (or TA).

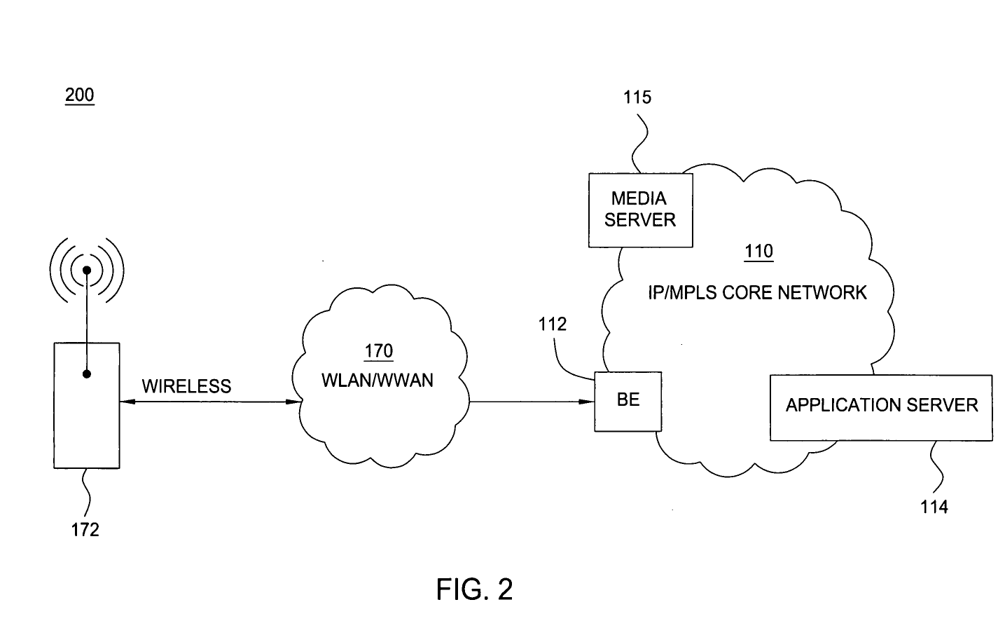

FIG. 2 illustrates an exemplary network 200 of the present invention for retrieving voicemail and email messages while being remote from the IP phone. For example, the customer is using a wireless device 172 to retrieve voicemails and emails from one or more servers. In one embodiment, the wireless device 172 is connected to a wireless access network 170. The wireless access network 170 is connected to an IP/MPLS core network 110 via a border element 112. In one embodiment, the VoIP or SoIP service provider may utilize an application server 114 to enable the customer to access services, and to retrieve emails and voicemails without an IP device.

In one embodiment, the application server 114 may utilize a media server 115 to interact with the customers in a format compatible with the customer's device and preferences. For example, if a customer has an endpoint device, e.g. a cell phone, that can handle packets below a specific size, then the application server 114 may utilize the media server 115 to create multiple smaller packets, and/or use data compression techniques to reduce the size of the message. For example, large images may be reduced to images with lower granularity.

If a customer has a preferred method for receiving the messages, then the media server is also used for conversion of messages to the preferred format. For example, a customer may wish to receive voicemail converted to a text format. Whereas, another customer may prefer to receive email converted to a speech format.

Thus, the current invention enables a service provider to provide the VoIP or SoIP services in one or more application servers and to receive preferences from the customer. Specifically, the service provider enables the customer to access the application server to retrieve message headers and messages according to the preferences without requiring the customer to use an IP phone that the customer typically uses to access IP services.

In one embodiment, the service provider also alerts the customer's mobile endpoint device when the customer receives an email or voicemail message. The customer may then review the message header(s) and selects a message to retrieve. Although the present invention is described above using one application server and one media server for converting text mail to a speech format and vice versa, those skilled in the art would realize multiple application servers and media servers may be used. Furthermore only the network elements needed to describe the present invention are illustrated in FIG. 2. It is not intended to show all the network components or connectivity needed to provide VoIP or SoIP services.

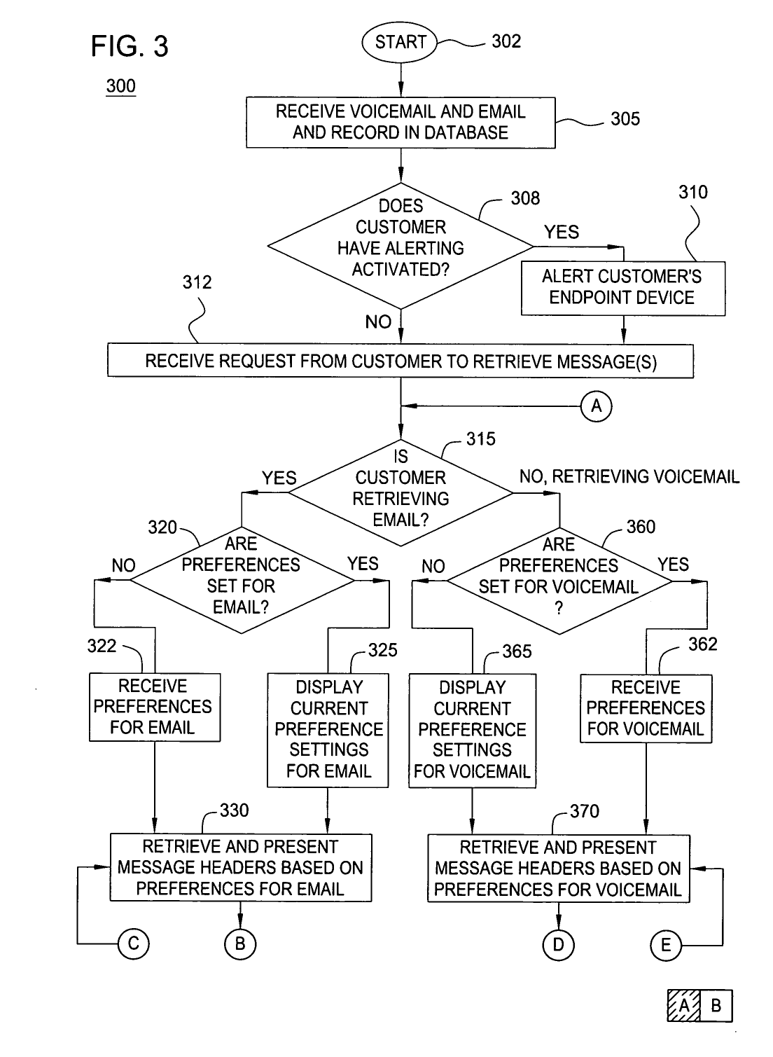

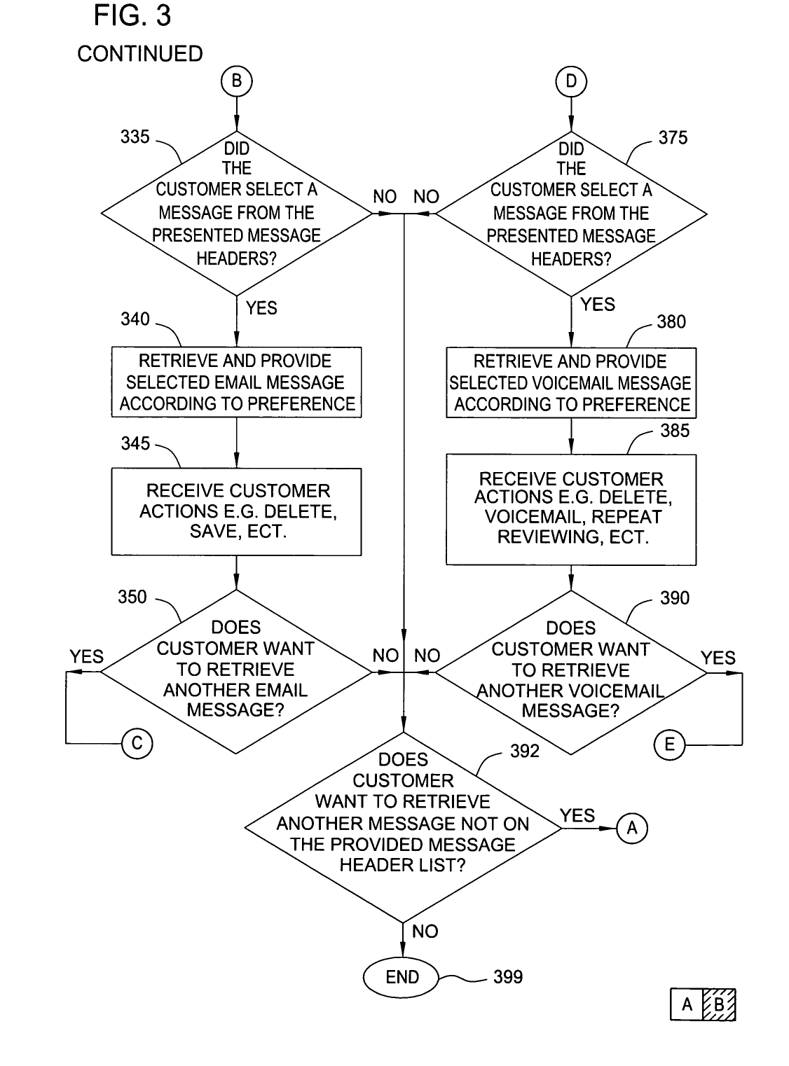

FIG. 3 illustrates a flowchart of a method 300 for retrieving voicemail and email messages while being remote from the IP phone. For example, the service provider may implement method 300 to provide email and voicemail retrieval services to a customer is remote from his or her IP phone (or terminal adaptor if TDM is used). For example, the service provider may provide an access number, e.g., a toll-free number, to dial and to access services from a wireless phone, etc.

Method 300 starts in step 302 and proceeds to step 305. In step 305, method 300 receives voicemail and email messages for a customer and records the messages in a database. For example, a caller may leave a voice message for a customer. The customer may later receive the message in audio (speech) format or text format based on the customer's preference. The voicemail and email messages can be stored in the same database or in separate databases. The service provider determines the implementation and the capabilities for each type of messaging service. The method then proceeds to step 308 to determine whether or not the customer has alerting activated.

In step 308, method 300 determines whether or not the customer has alerting activated. For example, the customer may wish to receive a text message in his/her wireless device when the application server receives a voicemail or an email for the customer. If the alert feature is activated, then the method proceeds to step 310 to alert the customer, e.g., a signal is sent to the customer's wireless device to cause the device to provide a visual signal (e.g., flashing LEDs), an audible signal (e.g., an audible tone) and/or a tactile signal (e.g., vibrating the wireless device). Otherwise, the method proceeds to step 312 to receive a request from the customer.

In one embodiment, the service provider enables the customer to provide conditions for receiving an alert. For example, a customer may specify to be alerted if an email or voicemail is received from a family member, from a client, from an emergency service provider such as a Hospital, etc. The customer is then alerted only if the conditions for alerting are met. Otherwise, the method proceeds to step 312.

In step 310, method 300 alerts the customer's endpoint device, e.g. a wireless device. It should be noted that the customer is alerted whether or not the customer is accessing messages at the time. For example, the customer may be retrieving other messages while he/she receives the alert for a specific message.

In step 312, method 300 receives a request from the customer to retrieve messages. Note that the customer may receive several email and/or voicemail messages prior to retrieval. The request may be initiated after an alert is sent to the customer or when the customer simply dials the access number. The access number can be used to retrieve both voicemail and email messages. Note that the voicemail and email messages were directed toward the customer's VoIP phone number and not directed at the wireless phone number. The method then proceeds to step 315 to determine whether the customer is retrieving voicemail or email messages.

In step 315, method 300 determines whether or not the customer is retrieving an email. If the customer is retrieving an email, then the method proceeds to step 320. If the customer is retrieving a voicemail, then the method proceeds to step 360.

In step 320, method 300 determines whether the preferences are set for email. For example, the customer may have specified to receive email headers in the order received, sorted by subject, importance, sender's address, any may have specified the length of message headers to be received. If the preferences are not set, then the method proceeds to step 322. Otherwise, the method proceeds to step 325 to display the current preference settings.

In step 322, method 300 receives one or more preferences for retrieving email from the customer. For example, a customer may choose to retrieve the messages in an audio format (e.g., broadly defined as a presentation format) in the order received by the server, retrieving only messages from a particular calling number, and so on. The preferences may also include options for storing messages, deleting messages and forwarding messages that are retrieved. For example, a customer may want to delete all retrieved messages. Another customer may prefer to keep the messages for a specific time, etc. It should be noted that step 322 is an optional step. Namely, method 300 allows a customer to specify preferences on a per access basis. However, if no preferences are received, then method 300 may simply implement a default preference, e.g., retrieving all new messages.

In step 325, method 300 displays current preference settings such that the customer may view the settings. For example, the display may show that the message headers will be provided in text format. It should be noted that step 325 is also an optional step. Namely, the customer may already know the set preferences and may not want to see the set preferences for each access.

In step 330, method 300 retrieves and presents the message headers to the customer based on email preferences. For example, if the server received two messages for the customer and the preferences are set to receive message headers in a text format, in chronological order, then the message headers are presented in the order received in a text format. The method then proceeds to step 335 to determine whether or not the customer selected a message for retrieval from the presented list of message headers.

In step 335, method 300 determines whether or not the customer selected a message for retrieval from the presented message headers. For example, in the above example, a customer may choose to retrieve the second message in the list provided in step 330. If the customer selects to retrieve a message from the provided list of message headers, then the method proceeds to step 340. Otherwise, the method proceeds to step 392 to determine whether or not the customer wishes to retrieve other messages that are not included in the message header list.

In step 340, method 300 retrieves and provides the selected email message according to the customer's preference. For example, a customer may prefer the server to send the entire text for the selected message to the customer's wireless device.

In step 345, method 300 waits for customer's input for action. For example, the customer's input for action may include: finish with reviewing the message, delete the message, save the message, forward the message, and the like.

In step 350, method 300 determines whether or not the customer wants to retrieve other email messages. If the customer wants to continue on retrieving other email messages, then the method proceeds to step 330 to retrieve and provide the message headers. Otherwise, the method proceeds to step 392 to determine whether or not the customer wishes to retrieve other messages that are not included in the message header list.

In step 360, method 300 determines whether the preferences are set for voicemail. For example, the customer may have specified to receive voicemail headers in a particular order (e.g., received order, sorted by subject order, importance flag order, sender's address order, and the like), and/or the customer may have specified the length of message headers to be received. If the preferences are not set, then the method proceeds to step 362. Otherwise, the method proceeds to step 365 to display the current preference settings.

In step 362, method 300 receives one or more preferences for retrieving voicemail from the customer. For example, a customer may choose to retrieve the messages converted to a text format (e.g., broadly defined as a presentation format) in the order received by the voicemail server. The preferences may also include options for storing, deleting, or forwarding the messages that are retrieved. For example, a customer may prefer to keep the messages for a specific duration, etc. It should be noted that step 362 is an optional step. Namely, method 300 allows a customer to specify preferences on a per access basis. However, if no preferences are received, then method 300 may simply implement a default preference, e.g., retrieving all new messages.

In step 365, method 300 displays current preference settings such that the customer may review the settings. For example, the display may show that the message header in a text format includes the telephone number of the calling party for received voicemail. It should be noted that step 365 is also an optional step. Namely, the customer may already know the set preferences and may not want to see the set preferences for each access.

In step 370, method 300 retrieves and presents the message headers to the customer based on voicemail preferences. For example, if the preference is set to receive message headers in a text format sorted by contact information, area code, and the like, then the message headers are presented according to the selected preferences. The method then proceeds to step 375 to determine whether or not the customer selected a message for retrieval from the presented list of message headers.

In step 375, method 300 determines whether or not the customer selected a message for retrieval from the presented message headers. For example a customer may choose to retrieve a message from a family member's phone number. If the customer selects to retrieve a message from the provided list of message headers, then the method proceeds to step 380. Otherwise, the method proceeds to step 392.

In step 380, method 300 retrieves and provides the selected voicemail message according to the customer's preference. For example, a customer may prefer the server to convert the voicemail message to a text format prior to delivering to the wireless device. The method then proceeds to step 385.

In step 385, method 300 waits for customer's input for action. For example, the customer's input for action may include: finish with reviewing the message, delete the message, save the message, forward the message, and the like.

In step 390, method 300 determines whether or not the customer wants to retrieve other voicemail messages. If the customer wants to continue on retrieving other voicemail messages, then the method proceeds to step 370 to retrieve and provide the message headers. Otherwise, the method proceeds to step 392.

In step 392, method 300 determines whether or not the customer wants to retrieve another message that is not on the presented list of message headers. For example, a customer may have finished reviewing voicemail and may want to proceed and review email messages instead, or vise versa. If the customer wants to retrieve other messages, then the method proceeds to step 315 to enable the customer to select the type of message to be retrieved. Otherwise, the method proceeds to step 399 to end processing the current request.

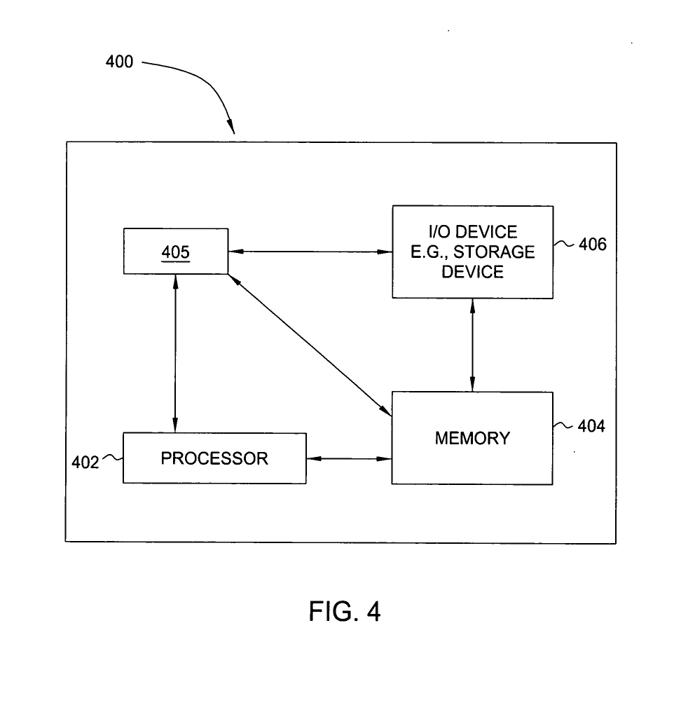

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for retrieving voicemail and email while remote from the IP phone and terminal adaptor associated with the VoIP or SoIP service, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, alarm interfaces, power relays and the like)).

It should be noted that the present invention can be implemented in software and/or in a combination of software and hardware, e.g., using application specific integrated circuits (ASIC), a general-purpose computer or any other hardware equivalents. In one embodiment, the present module or process 405 for retrieving voicemail and email while remote from the IP phone and terminal adaptor associated with the VoIP or SoIP service can be loaded into memory 404 and executed by processor 402 to implement the functions as discussed above. As such, the present method 405 for retrieving voicemail and email while remote from the IP phone and terminal adaptor associated with the VoIP or SoIP service (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for allowing a customer to access a stored message in a communication network, comprising:
storing at least one message destined to a first endpoint device of a customer;
receiving a request to access said at least one message from a second endpoint device, where said first endpoint device is different from said second endpoint device; and
presenting said at least one message to said second endpoint device in a presentation format.

2. The method of claim 1, wherein said communication network is a Voice over Internet Protocol (VoIP) network or a Service over Internet Protocol (SOIP) network.

3. The method of claim 1, further comprising:
sending an alert signal to said second endpoint device to indicate presence of said at least one message.

4. The method of claim 3, wherein said alert signal causes at least one of: a visual signal, an audible signal or a tactile signal to be activated on said second endpoint device.

5. The method of claim 1, wherein said first endpoint device is an Internet Protocol (IP) endpoint device that is employed by said customer to access at least one IP service on said communication network.

6. The method of claim 1, wherein said at least one message comprises at least one email message and at least one voicemail message.

7. The method of claim 6, wherein said presentation format comprises an audio format or a text format.

8. The method of claim 7, wherein said at least one email message is presented to said second endpoint device in said audio format.

9. The method of claim 7, wherein said at least one voicemail message is presented to said second endpoint device in said text format.

10. The method of claim 7, further comprising:
presenting an option to said customer to select said presentation format.

11. The method of claim 10, wherein said option is presented on a per access basis.

12. The method of claim 7, wherein said presentation format is based on a predefined preference.

13. The method of claim 1, wherein said second endpoint device is a wireless endpoint device.

14. A computer-readable medium having stored thereon a plurality of instructions, the plurality of instructions including instructions which, when executed by a processor, cause the processor to perform the steps of a method for allowing a customer to access a stored message in a communication network, comprising:
storing at least one message destined to a first endpoint device of a customer;
receiving a request to access said at least one message from a second endpoint device, where said first endpoint device is different from said second endpoint device; and
presenting said at least one message to said second endpoint device in a presentation format.

15. The computer-readable medium of claim 14, further comprising:
sending an alert signal to said second endpoint device to indicate presence of said at least one message.

16. The computer-readable medium of claim 14, wherein said first endpoint device is an Internet Protocol (IP) endpoint device that is employed by said customer to access at least one IP service on said communication network.

17. The computer-readable medium of claim 14, wherein said at least one message comprises at least one email message and at least one voicemail message.

18. The computer-readable medium of claim 17, wherein said presentation format comprises an audio format or a text format.

19. The computer-readable medium of claim 18, wherein said at least one email message is presented to said second endpoint device in said audio format, or wherein said at least one voicemail message is presented to said second endpoint device in said text format.

20. An apparatus for allowing a customer to access a stored message in a communication network, comprising:
means for storing at least one message destined to a first endpoint device of a customer;
means for receiving a request to access said at least one message from a second endpoint device, where said first endpoint device is different from said second endpoint device; and
means for presenting said at least one message to said second endpoint device in a presentation format.
